(19) United States
(12) Patent Application Publication
(10) Pub. No.: US 2021/0304076 A1
(43) Pub. Date: Sep. 30, 2021

(54) METHOD, APPARATUS, DEVICE AND STORAGE MEDIUM FOR INFORMATION PROCESSING

(71) Applicant: NEC CORPORATION, Tokyo (JP)

(72) Inventors: Yu WU, Beijing (CN); Chunchen Liu, Beijing (CN)

(73) Assignee: NEC CORPORATION, Tokyo (JP)

(21) Appl. No.: 17/218,639

(22) Filed: Mar. 31, 2021

(30) Foreign Application Priority Data
Mar. 31, 2020 (CN) 202010246058.X

(51) Int. Cl. G06N 20/00; G06N 5/02

(52) U.S. Cl. CPC G06N 20/00; G06N 5/022

(57) ABSTRACT

The present disclosure relates to a method, apparatus, device and storage medium for information processing. Specifically, a method is proposed for information processing. In the method, multiple samples associated with multiple ordinal data in an application system are obtained, each sample among the multiple samples comprising multiple dimensions, a dimension among the multiple dimensions corresponding to ordinal data among the multiple ordinal data. Based on the multiple samples, a first causal structure and a second causal structure representing the causality between the multiple ordinal data are provided, the second causal structure being obtained based on the first causal structure. Further, there is provided an apparatus, device and storage medium for information processing. With example implementations of the present disclosure, the first causal structure and the second causal structure are provided based on the multiple samples, the causality may be determined in a simple and effective way, and the credibility of the causality may be increased.

### FIELD

Various implementations of the present disclosure relate to the field of machine learning, and more specifically, to a method, apparatus, device and computer storage medium for information processing based on machine learning technology.

### BACKGROUND

Machine learning technology has been widely applied in various fields so as to seek causality between multiple variables. For example, in the field of mechanical manufacture, part blanks have to undergo rough machining, finishing and grinding processes to produce parts that meet predetermined shape requirements. It will be understood that intermediate products of different quality levels might be produced in each process. The quality level of intermediate products will directly or indirectly determine whether final products are qualified. For another example, various transmission devices in a power transmission system might be in different operating states (for example, good, normal, abnormal, alarm, etc.). These states might directly or indirectly determine an output state of the power transmission system and/or power loss due to transmission.

Generally speaking, causality serves as a basis for other subsequent processing and analysis. How to determine more reliable causality based on collected data will affect the accuracy of subsequent operations to some extent. Therefore, it is desirable to provide a technical solution for determining causality, and it is desired that the technical solution may determine causality between multiple variables in a more accurate and effective way.

### SUMMARY

Example implementations of the present disclosure provide a technical solution for information processing.

According to a first aspect of the present disclosure, a method is proposed for information processing. In the method, multiple samples associated with multiple ordinal data in an application system are obtained, each sample among the multiple samples comprising multiple dimensions, a dimension among the multiple dimensions corresponding to ordinal data among the multiple ordinal data. Based on the multiple samples, a first causal structure and a second causal structure representing the causality between the multiple ordinal data are provided, the second causal structure being obtained based on the first causal structure.

According to a second aspect of the present disclosure, an apparatus is proposed for information processing. The apparatus comprises: an obtaining module configured to obtain multiple samples associated with multiple ordinal data in an application system, each sample among the multiple samples comprising multiple dimensions, a dimension among the multiple dimensions corresponding to ordinal data among the multiple ordinal data; and a providing module configured to, based on the multiple samples, provide a first causal structure and a second causal structure representing the causality between the multiple ordinal data, the second causal structure being obtained based on the first causal structure.

According to a third aspect of the present disclosure, an electronic device is proposed. The device comprises: at least one processing unit; at least one memory, coupled to the at least one processing unit and storing instructions to be executed by the at least one processing unit, the instructions, when executed by the at least one processing unit, causing the device to perform a method according to the first aspect.

According to a fourth aspect of the present disclosure, a computer-readable storage medium is provided, containing computer-readable program instructions stored thereon which are used to perform a method according to the first aspect.

The Summary is to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the more detailed description in the accompanying drawings, features, advantages and other aspects of implementations of the present disclosure will become more apparent. Several implementations of the present disclosure are illustrated schematically and are not intended to limit the present invention. In the drawings:

FIG. 1A schematically shows a block diagram of an application environment in which implementations of the present invention may be implemented;

FIG. 1B schematically shows a block diagram of another application environment in which implementations of the present invention may be implemented;

FIG. 2 schematically shows a block diagram of a process of determining causality between multiple ordinal data according to one implementation of the present disclosure;

FIG. 3 schematically shows a flowchart of a method for information processing according to one implementation of the present disclosure;

FIG. 4 schematically shows a block diagram of a further process of determining causality between multiple ordinal data according to one implementation of the present disclosure;

FIG. 5A schematically shows a block diagram of a constraint between multiple ordinal data according to one implementation of the present disclosure;

FIG. 5B schematically shows a block diagram of an initial causal structure that is built based on expert knowledge according to one implementation of the present disclosure;

FIG. 6 schematically shows a block diagram of a further process of determining causality between multiple ordinal data according to one implementation of the present disclosure;

FIG. 7 schematically shows a flowchart of a further method for determining causality between multiple ordinal data according to one implementation of the present disclosure;

FIG. 8 schematically shows a block diagram of causality presented in a directed acyclic graph according to one implementation of the present disclosure;

FIG. 9 schematically shows a block diagram of an apparatus for determining causality between multiple ordinal data according to one implementation of the present disclosure; and

FIG. 10 shows a schematic block diagram of a device for information processing according to one implementation of the present disclosure.

### DETAILED DESCRIPTION OF IMPLEMENTATIONS

The preferred example implementations of the present disclosure will be described in more detail with reference to the drawings. Although the drawings illustrate the preferred example implementations of the present disclosure, it should be appreciated that the present disclosure can be implemented in various ways and should not be limited to the example implementations explained herein. On the contrary, these example implementations are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example implementation” and “one implementation” are to be read as “at least one example implementation.” The term “a further example implementation” is to be read as “at least a further example implementation.” The terms “first”, “second” and so on can refer to same or different objects. The following text also can comprise other explicit and implicit definitions.

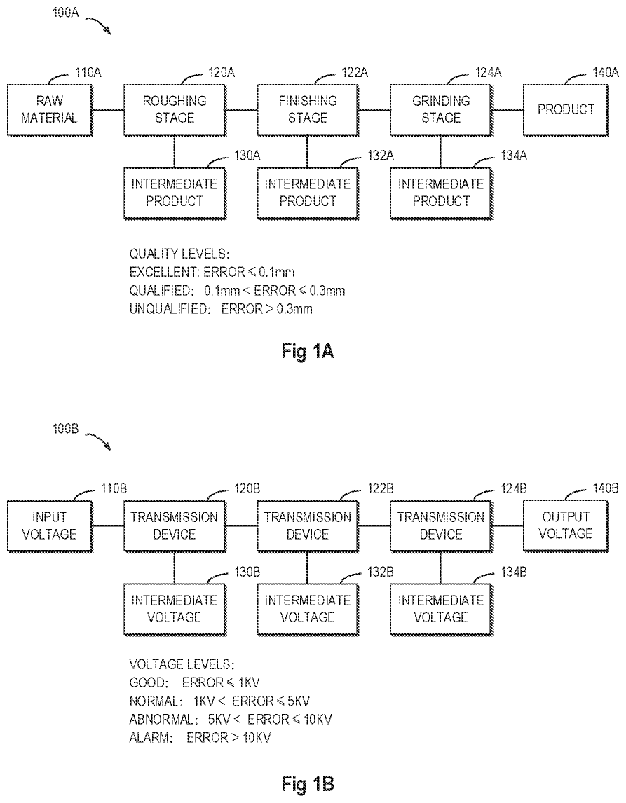

For the sake of description, first, a brief introduction is present to an application environment of example implementations of the present disclosure. The example implementations of the present disclosure involve determining causality between ordinal data. First of all, the meaning of ordinal data is introduced with reference to FIGS. 1A and 1B. FIG. 1A schematically shows a block diagram 100A of an application environment in which a method according to example implementations of the present disclosure may be implemented.

FIG. 1A shows multiple processing stages involved in a machining process. Suppose it is desirable to process a raw material 110A into a product 140A with a predefined size, and the raw material 110A may undergo a roughing stage 120A, a finishing stage 122A and a grinding stage 124A, respectively. At this point, intermediate products 130A, 132A and 134A may be formed after the roughing stage 120A, the finishing stage 122A and the grinding stage 124A, respectively. Since factors involved in the process of each part vary, intermediate products will have different quality levels. For example, excellent may indicate that the error of an intermediate product is ≤0.1 mm, qualified may indicate that the error of an intermediate product is >0.1 mm and ≤0.3 mm, and unqualified may indicate that the error of an intermediate product is >0.3 mm. These three levels may be denoted by integers 0, 1 and 2, respectively. It will be understood that quality levels of intermediate products in one processing stage have been shown for illustration purposes only, and thresholds for determining error levels in each stage may have the same or different values.

FIG. 1B schematically shows a block diagram 100B of a further application environment in which a method according to example implementations of the present disclosure may be implemented. FIG. 1B schematically shows a power transmission process. An input voltage 110B may be transmitted through transmission devices 120B, 122B and 124B, respectively, and then an output voltage 140B may be obtained. To reduce the loss during power transmission, ultra-high voltage circuit transmission mode can be used. An intermediate voltage 130B may be obtained at the transmission device 120B, an intermediate voltage 132B may be obtained at the transmission device 122B, and an intermediate voltage 134B may be obtained at the transmission device 124B. States of intermediate voltages may have different levels: good with voltage error ≤1 KV; normal with error >1 KV and ≤5 KV; abnormal with error >5 KV and ≤10 KV; alarm with error >10 KV. The four levels may be represented by integers 0, 1, 2 and 3, respectively. It will be understood that thresholds for determining error levels at each transmission device may have the same or different values.

The above quality levels of the intermediate products and the voltage levels belong to “ordinal data.” Here ordinal data represents statistical data, which uses levels to represent measured values. Ordinal data has no measurement unit or absolute zero, but only has “equal to,” “not equal to” and “sequential relations” between them.

Technical solutions have been proposed to determine the causality between continuous variables and/or discrete variables. Due to the particularity of ordinal data, these technical solutions cannot be applied to ordinal data. Although technical solutions have been proposed to determine the causality between ordinal data, their precision is rather low and they cannot accurately describe the causality between various ordinal data. Therefore, it is desirable to determine causality between multiple ordinal data in a more accurate and effective way.

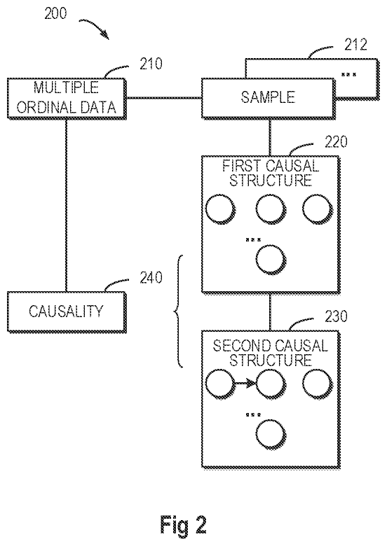

To at least partly solve the drawbacks in the above technical solutions, a method for information processing is provided according to example implementations of the present disclosure. First with reference to FIG. 2, a brief description is presented the architecture of example implementations of the present disclosure. FIG. 2 schematically shows a block diagram 200 of the process of determining causality between multiple ordinal data according to one implementation of the present disclosure.

As shown in FIG. 2, multiple samples 212 (e.g., quality levels of parts in various processes shown in FIG. 1) associated with multiple ordinal data 210 in an application system may be collected. With the multiple samples 212 associated with the multiple ordinal data 210, based on a first causal structure 220 of causality 240, a second causal structure 230 may be obtained. It will be understood that since both the first causal structure 220 and the second causal structure 230 are graphical representations of the causality 240, it is possible to find the causality 240 that best matches the multiple samples 212 step by step and make the determined causality 240 more credible.

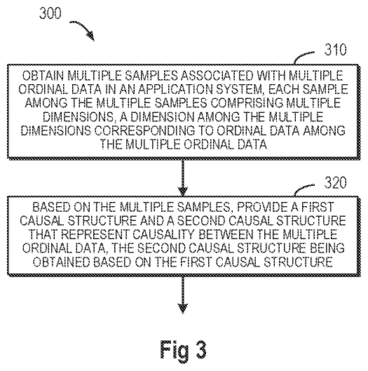

More details about example implementations of the present disclosure will be described with reference to FIG. 3. This figure schematically shows a flowchart of a method 300 for information processing according to one implementation of the present disclosure. At block 310, the multiple samples 212 associated with the multiple ordinal data 210 are obtained. Here, each sample among the multiple samples 212 comprises multiple (denoted by an integer n) dimensions, and a dimension among the multiple dimensions corresponds to ordinal data among the multiple ordinal data 210. In other words, dimensions and ordinal data may have a one-to-one correspondence. In the application system for machining as shown in FIG. 1A, the multiple ordinal data 210 may comprise quality levels collected in various processing stages. One sample may comprise quality levels of one part in various processing stages. When the process comprises 3 stages (i.e., the roughing stage, the finishing stage and the grinding stage) and it is desirable to determine whether final products are qualified, each sample may comprise 3+1=4 dimensions. Examples of the multiple samples are schematically shown in Table 1 below.

TABLE 1
Examples of Multiple Samples

| Ordinal | Ordinal | Ordinal | Ordinal |
|---|---|---|---|
| data x₁ | data x₂ | data x₃ | data x₄ |
| (quality levels | (quality levels | (quality levels | (whether |
| in roughing | in finishing | in grinding | products |
| stage) | stage) | stage) | are qualified) |
| X11 | X12 | X13 | X14 |
| X21 | X22 | X23 | X24 |
| . . . | . . . | . . . | . . . |
| Xm1 | Xm2 | Xm3 | Xm4 |

In Table 1, the first three columns represent the collected quality levels (e.g., denoted by 0, 1 and 2) of intermediate products in the roughing stage, the finishing stage and the grinding stage, respectively, and the fourth column indicates whether a product is qualified (e.g., 0 denotes unqualified, and 1 denotes qualified). At this point, each row in Table 1 represents one sample. The first row shows samples of the first part in the process, data X11, X12 and X13 in the first 3 dimensions correspond to quality levels of intermediate products in the roughing stage, the finishing stage and the grinding stage, respectively. Data X14 in the last dimension corresponds to a fact whether the final product is qualified. Similarly, the m^{th} row shows samples of the m^{th} part in the process.

It will be understood that Table 1 merely illustrates an example data structure of the sample, and in other application systems, the sample may comprise more, less or different dimensions. For example, in the power transmission system shown in FIG. 1B, ordinal data x₁ to x₃ may represent voltage levels at 3 transmission devices, ordinal data x₄ may represent an output state of the power system, and ordinal data x₅ may represent power loss.

At block 320, the first causal structure 220 and the second causal structure 230 that indicate the causality between the multiple ordinal data are provided based on the multiple samples, here the second causal structure 230 is obtained based on the first causal structure 220. It will be understood that the first causal structure 220 and the second causal structure 230 here may be two intermediate results in the causality determining process. The second causal structure 230 may be continuously obtained based on the first causal structure 220. According to example implementations of the present disclosure, the first causal structure 220 comprises an initial causal structure of the causality, and the second causal structure 230 comprises an adjacent causal structure of the causality, here the adjacent causal structure is obtained from the adjacent scope of the initial causal structure.

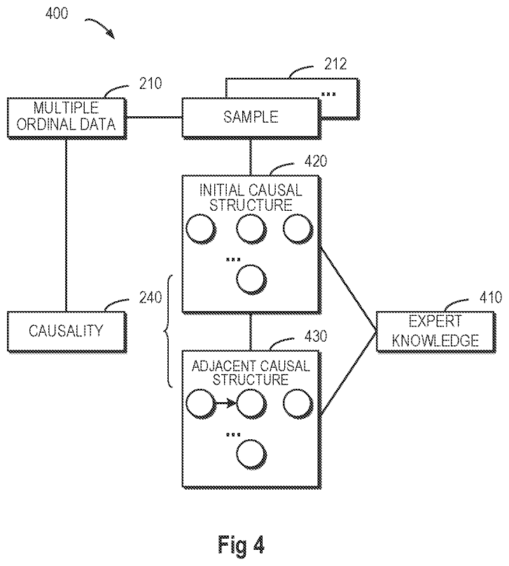

It will be understood that in the starting stage of the operation of the method 300, since the structure of the causality 240 is unknown, the initial causal structure may be set to empty. With reference to FIG. 4, this figure schematically shows a block diagram 400 of a further process of determining causality between multiple ordinal data according to one implementation of the present disclosure. When the initial causal structure 420 is described as a directed acyclic graph (DAG), the initial causal structure 420 only comprises multiple nodes corresponding to multiple ordinal data, respectively, while there is no edge between the multiple nodes.

With example implementations of the present disclosure, search may be continuously performed in the adjacent scope of the initial causal structure 420. In other words, starting from the initial causal structure 420 that does not comprise any edge, edges describing causality between two ordinal data may be continuously added into the graph structure so as to find the causality 240 that best matches the multiple samples 212.

Usually, as measured values of the multiple ordinal data have been observed for a long time, some experience might have been accumulated as to whether two ordinal data have causality. A constraint on the causality between two ordinal data may be referred to as expert knowledge. At this point, expert knowledge may be introduced to the process of determining the causality 240. As shown in FIG. 4, expert knowledge 410 may be received and applied to different stages for determining the causality 240. According to example implementations of the present disclosure, the initial causal structure 420 may be determined using the expert knowledge 410, an adjacent causal structure 430 may be provided based on the multiple samples and the expert knowledge 410. Further, it may be verified based on the expert knowledge 410 whether the adjacent causal structure 430 conforms to known experience.

It will be understood that since the expert knowledge 410 reflects professional experience accumulated by people, by using the expert knowledge 410 to assist in determining the adjacent causal structure 430, on the one hand it is possible to reduce the amount of calculation in the search process, and on the other hand, it is possible to cause the obtained adjacent causal structure 430 to better conform to the historical experience. Hereinafter, the specific meaning of the expert knowledge 410 is first described. According to example implementations of the present disclosure, the expert knowledge 410 may comprise content in various respects. Regarding first ordinal data and second ordinal data among the multiple ordinal data, the expert knowledge comprises at least one of: the first ordinal data and the second ordinal data have direct causality; the first ordinal data and the second ordinal data do not have direct causality; the first ordinal data is the cause of the second ordinal data; the first ordinal data is not the cause of the second ordinal data; the first ordinal data is the result of the second ordinal data; and the first ordinal data is not the result of the second ordinal data.

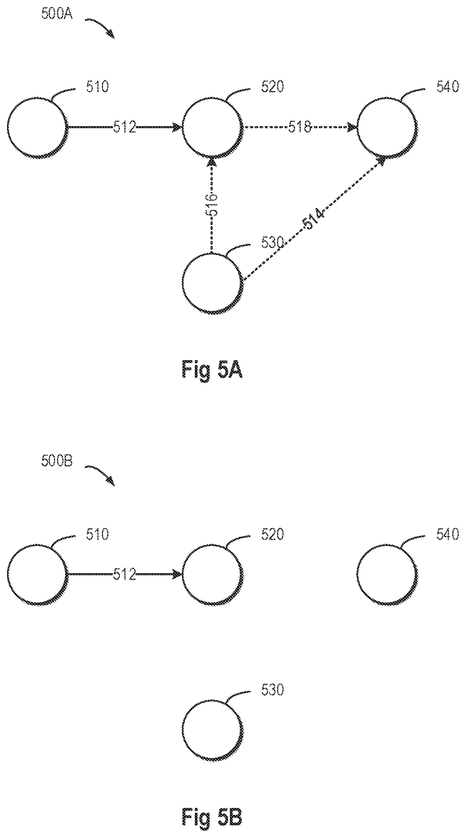

More details about the expert knowledge 410 will be described with reference to FIG. 5A. This figure schematically shows a block diagram 500A of a constraint between multiple ordinal data according to one implementation of the present disclosure. For the purpose of simplicity, FIG. 5A merely illustrates a graph structure with 4 nodes, where the 4 nodes correspond to the 4 ordinal data x₁ to x₄ in Table 1, respectively. The expert knowledge 410 may, for example, indicate ordinal data x₁ and ordinal data x₂ have direct causality. It will be understood that causality is directional, so at this point the direction between an edge 512 from a node 510 (corresponding to ordinal data x₁) and a node 520 (corresponding to ordinal data x₂) is from the node 510 to the node 520.

The expert knowledge 410 may indicate that two ordinal data do not have direct causality. For example, it may be specified that ordinal data x₁ and ordinal data x₂ do not have direct causality, at which point there is no edge between the node 510 (corresponding to ordinal data x₁) and a node 530 (corresponding to ordinal data x₃).

The expert knowledge 410 may indicate that one ordinal data is the cause of another ordinal data. For example, it may be specified that ordinal data x₃ is the cause of ordinal data x₄. At this point, ordinal data x₃ may be the direct cause of ordinal data x₄ (i.e., there may be an edge 524 between the node 530 and a node 540) or ordinal data x₃ may be the indirect cause of ordinal data x₄ (i.e., there may be a path between the node 530 and the node 540, for example, the node 530 points to the node 540 via edges 516 and 518, etc.).

The expert knowledge 410 may indicate that one ordinal data is not the cause of another ordinal data. For example, it may be specified that ordinal data x₃ is not the cause of ordinal data x₄. This means that ordinal data x₃ is neither the direct cause nor the indirect cause of ordinal data x₄. That is, there is neither an edge nor a path between the nodes 530 and 540.

The expert knowledge 410 may indicate that one ordinal data is the result of another ordinal data. For example, it may be specified that ordinal data x₄ is the result of ordinal data x₃. At this point, ordinal data x₄ may be the direct result of ordinal data x₃ (i.e., there may be an edge 514 between the node 530 and the node 540) or ordinal data x₄ may be the indirect result of ordinal data x₃ (i.e., there may be a path between the node 530 and the node 540, for example, the node 530 points to the node 540 via the edges 516 and 518, etc.).

The expert knowledge 410 may indicate that one ordinal data is not the result of another ordinal data. For example, it may be specified that ordinal data x₄ is not the result of ordinal data x₃. This means that ordinal data x₄ is neither the direct result nor the indirect result of ordinal data x₃. That is, there is neither an edge nor a path between the nodes 530 and 540.

With example implementations of the present disclosure, a constraint that the causality 240 should satisfy may be pre-specified based on the above types of expert knowledge. In this way, the search efficiency may be increased, and a search result that better conforms to historical experience may be provided.

According to example implementations of the present disclosure, the initial causal structure 420 may be built based on the expert knowledge 410. Suppose the expert knowledge 410 specifies: ordinal data x₁ and ordinal x₂ have direct causality. Then, at this point, the initial causal structure 420 may be represented as shown in FIG. 5B. In FIG. 5B, the initial causal structure 420 is no longer empty but may comprise the edge 512 pointing from the node 510 to the node 520. Starting from an initial causal structure 500B, the adjacent causal structure 430 may be searched for in the adjacent scope of the initial causal structure. With example implementations of the present disclosure, on the one hand, the excessive calculation overhead caused by searching from an empty structure may be avoided; and on the other hand, the initial causal structure 500B that better conforms to historical experience may be used as a basis for subsequent searches. Thus, the adjacent causal structure 430 obtained in a subsequent search process may better match the actual situation.

According to example implementations of the present disclosure, the found adjacent causal structure 430 may be verified based on the expert knowledge 410. For example, in the starting stage for obtaining the adjacent causal structure 430, first a search may start from the “empty” initial causal structure 420, and at this point the expert knowledge 410 may not be introduced. After the adjacent causal structure 430 is found, it may be judged whether each edge in the adjacent causal structure 430 meets the constraint in the expert knowledge 410 or not. If yes, then the edge may be kept; if not, the edge may be deleted.

Suppose that the found adjacent causal structure 430 indicates that ordinal data x₂ and ordinal data x₁ have direct causality, while the expert knowledge 410 defines ordinal data x₂ is not the cause of ordinal data x₁. At this point, the edge representing the direct causality may be deleted from the adjacent causal structure 430. With example implementations of the present disclosure, based on the expert knowledge 410, it may be verified whether the found adjacent causal structure 430 conforms to the actual situation, and errors in violation with historical experience in the adjacent causal structure 430 may be corrected effectively.

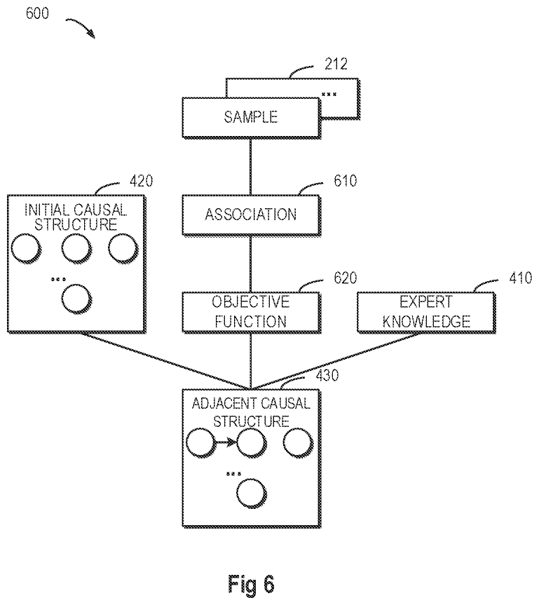

According to example implementations of the present disclosure, an objective function for obtaining causality may further be generated based on the multiple samples. Here, the objective function may measure whether the found causality 240 conforms to the collected multiple samples 212. The higher a value of the objective function is, the closer to the actual causality the found causality 240 is. Hereinafter, more details on building the objective function will be described with reference to FIG. 6.

FIG. 6 schematically shows a block diagram 600 of a further process of determining causality between multiple ordinal data according to one implementation of the present disclosure. As depicted, an association 610 associated with the multiple samples 212 may be determined. Specifically, the association 610 may be determined based on polychoric correlation technology. Here polychoric correlation is the technology that estimates a correlation between two continuous latent variables of theoretically normal distribution based on two explicit ordinal data (e.g., the collected samples 212).

It will be understood that latent variables mentioned herein refer to intrinsic physical attributes corresponding to ordinal data. For example, in the machining system, the value of ordinal data x₁ is the quality level denoted as 0, 1 or 2. The latent variable corresponding to ordinal data x₁ refers to the actual quality of the intermediate product 130A. The actual quality may continuously change and may be denoted in units of mm, while ordinal data x₁ may be denoted in levels divided by a predetermined threshold (e.g., 0.1 mm and 0.3 mm, etc.) and may not have a unit.

According to example implementations of the present disclosure, multiple threshold estimations associated with one ordinal data among the multiple ordinal data may be determined based on the multiple samples 212. The i^{th} ordinal data xᵢ is denoted by assigning a corresponding latent variable (e.g., denoted as xᵢ′) to a corresponding level according to a predetermined threshold. For the sake of calculation, suppose that the actual quality changes continuously and conforms to a Gaussian distribution. At this point, a set of predetermined thresholds (e.g., 0.1 mm and 0.3 mm, etc.) used for obtaining ordinal data xᵢ may be derived based on the distribution of ordinal data xᵢ. It will be understood that for different ordinal data x₁, the number and values of the obtained set of predetermined thresholds may differ from the number and values of another set of predetermined thresholds obtained for another ordinal data.

Further, the association 610 may be determined based on the determined multiple threshold estimations and the multiple samples 212. Specifically, a matrix representation Σ of the association 610 may be determined based on the maximum likelihood estimation. In actual calculation, the maximum likelihood estimation is an effective way for simplifying calculation. With example implementations of the present disclosure, a more accurate association 610 may be obtained at a smaller cost. In the matrix representation Σ of the association 610, an element beyond diagonals represents an association between the multiple ordinal data.

According to example implementations of the present disclosure, an objective function 620 may be generated based on the association 610. The objective function 620 may be generated in various ways, for example, by using Formula 1 below.

$$f = - \frac{1}{2} log ( \vert \sum \vert ) - \frac{1}{2} t r ( {\sum }^{- 1} \hat{\sum } ) \qquad Formula 1$$

where f denotes the generated objective function 620, Σ denotes the association 619, tr( ) denotes a sum of diagonal edges, “−1” denotes an inverse matrix operation, and \hat{Σ} denotes the adjacent causal structure found in the search process.

It will be understood that Formula 1 merely shows one illustrative implementation for generating the objective function 620. According to example implementations of the present disclosure, more or less factors may be considered, and the objective function 620 may have a different mathematical representation. For example, the objective function 620 may be represented based on Formula 2 below.

f=−log(|Σ|)−tr(Σ⁻¹\hat{Σ}) Formula 2

According to example implementations of the present disclosure, a search may be continuously performed in the adjacent scope of the initial causal structure 420, and a value of the objective function 620 may be determined based on each of the found adjacent causal structures 430. During the search, within the adjacent scope of the initial causal structure, an edge may be added into the initial causal structure 420 to form the adjacent causal structure 430. In the above Formula 1, Σ is denoted as a known matrix, and as the search proceeds, the corresponding \hat{Σ} is also known in a situation where the adjacent causal structure 430 is determined. Thus, the value of the corresponding objective function 620 may be determined.

According to example implementations of the present disclosure, a search may be continuously performed so as to find the adjacent causal structure 430 that satisfies a predetermined condition. For example, such an adjacent causal structure 430 that maximizes the objective function 620 may be found. In this way, the most credible causality may be found from a large number of candidates of the causality 240. For another example, to reduce the amount of calculation in the search process, the number of searches performed may be specified, and a further search stops when the number is reached. The adjacent causal structure 430 that will maximize the objective function 620 may be selected as the causality 240 from the found adjacent causal structures 430. With example implementations of the present disclosure, a balance may be maintained between the amount of calculation and the accuracy, so as to find a more accurate causality with limited computing resources.

According to example implementations of the present disclosure, the process of searching for the adjacent causal structure 430 may be performed iteratively. For example, a further adjacent causal structure of a current adjacent causal structure may be searched for in the adjacent scope of the current adjacent causal structure. Here the further adjacent causal structure is obtained by the above method, and the objective function may be caused to satisfy a predetermined condition. Specifically, a further search may be performed in the adjacent scope of the current adjacent causal structure 430, so as to find the further adjacent causal structure that satisfies the expert knowledge 410 and maximizes the objective function 620.

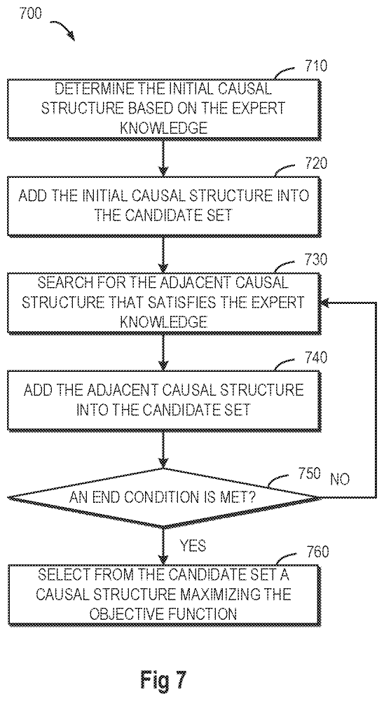

According to example implementations of the present disclosure, a candidate set may be built so as to store the adjacent causal structure 430 that is found each time. Further, a search may be continuously performed in the adjacent scope for a new adjacent causal structure, until a graph structure maximizing the objective function is found. At this point, the graph structure is the causality 240 that best matches the multiple ordinal data. Hereinafter, specific steps of iteratively performing a search will be described with reference to FIG. 7.

FIG. 7 schematically shows a flowchart of a further method 700 for determining causality between multiple ordinal data according to one implementation of the present disclosure. At block 710, the initial causal structure 420 may be determined based on the expert knowledge 410. In the starting stage of the method 700, the candidate set is empty. At block 720, the initial causal structure 420 may be added into the candidate set. At block 730, a search is performed in the adjacent scope (where searches in the candidate set have not been performed yet) for a graph structure, so as to find the adjacent causal structure 430 that satisfies the expert knowledge 410. At block 740, the found adjacent causal structure 430 may be added into the candidate set. At block 750, if an end condition is met (e.g., the predetermined number of searches has been reached), the method 700 proceeds to block 760; otherwise, the method 700 returns to block 730 so as to perform a next search. At block 760, a graph structure maximizing the objective function may be selected from the candidate set. At this point, the selected graph structure is the causality 240 that best matches the multiple samples.

With example implementations of the present disclosure, all graph structures that meet the expert knowledge 410 may be found in a simple and effective way, and a graph structure that will maximize the objective function may be selected as the final causality 240 from these found graph structures. In this way, the most credible causality 240 may be found effectively.

According to example implementations of the present disclosure, the expert knowledge 410 may further be used as a constraint for searching for the adjacent causal structure 430. At this point, when the expert knowledge 410 exists, such an adjacent causal structure 430 that meets both the following two criteria may be searched for: (1) the adjacent causal structure 430 meets the expert knowledge 410, and (2) the adjacent causal structure 430 maximizes the objective function 620. With example implementations of the present disclosure, the accuracy of the search process may further be improved, and the found adjacent causal structure 430 may be made to better conform to the historical experience.

According to example implementations of the present disclosure, an effective sample size associated with the multiple samples 212 may further be received. The effective sample size is an importance concept in statistics, and its value is closely related to the accuracy of the prediction process. A user-specified effective sample size may be received, and a parameter in the objective function 620 may be flexibly adjusted based on the effective sample size when generating the objective function 620.

According to example implementations of the present disclosure, the number of effective causality (i.e., the number of non-zero elements in the causality matrix) among the causality 240 may be considered. Since the number of causality between different ordinal data is different, adjusting the objective function 620 based on the number of effective causality may add a controllable parameter to the causality determining process, so as to flexibly adjust the objective function 620 with respect to different application environments.

According to example implementations of the present disclosure, the objective function 620 may be determined based on Formula 3 below.

$$f = - \frac{1}{2} log ( \vert \sum \vert ) - \frac{1}{2} t r ( {\sum }^{- 1} \hat{\sum } ) + \frac{1}{2} {‖ B ‖}_{0} log ( \hat{n} ) \qquad Formula 3$$

where f denotes the generated objective function 620, Σ denotes the association 610, tr( ) denotes a sum of diagonal edges, “−1” denotes an inverse matrix operation, \hat{Σ} denotes the adjacent causal structure found in the search process, ∥B∥₀ denotes the number of effective causality, and \hat{n} denotes the effective sample size.

In the above Formula 3, suppose X′ indicates that the latent variable matrix X′=X′=(X′₁, X′₂, . . . , X′ₙ)^{T}, and e indicates that mutually independent Gaussian noise e=(e₁, e₂, . . . , eₙ)^{T} that follows N (0, Ψ), wherein Ψ denotes a diagonal matrix with positive diagonal elements. The causality may be represented as a matrix B, wherein an element at the position (i, j) in the matrix B is denoted as Bᵢⱼ. It will be understood that the causality here refers to the causality between latent variables corresponding to ordinal data. In the matrix B, Bᵢⱼ=0 indicates that the i^{th} latent variable corresponding to ordinal data xᵢ and the j^{th} latent variable corresponding to ordinal data xⱼ do not have causality; Bᵢⱼ≠0 indicates that the i-th latent variable and the j-th latent variable have causality, and the strength of the causality is Bᵢⱼ.

According to example implementations of the present disclosure, a linear assumption may be made X′=BX′+e, at which point it may be determined that Σ=(I−B)\hat{ }{−1}Ψ(I−B)\hat{ }{−T}. It will be understood that specific details about mathematical operation will be omitted in the context of the present disclosure. Those skilled in the art may determine specific values of various formulas according to the general principle of mathematical operation.

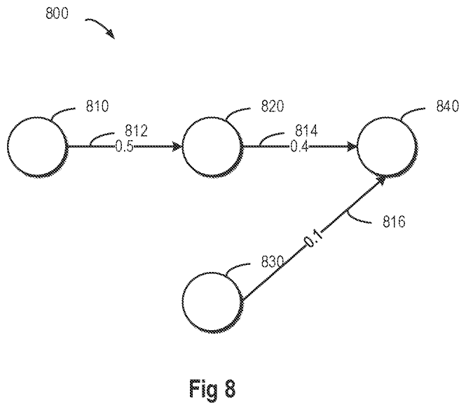

How to determine the causality 240 has been described above. According to example implementations of the present disclosure, the found causality 240 may be presented in various ways. For example, the adjacent causal structure may be presented in a DAG. Specifically, FIG. 8 schematically shows a block diagram 800 of causality presented in a directed acyclic graph according to one implementation of the present disclosure. As depicted, nodes 810, 820, 830 and 840 represent the multiple ordinal data x₁, x₂, x₃ and x₄, respectively. An edge in the graph indicates that two ordinal data have direct causality. For example, an edge 812 indicates that ordinal data x₁ is the direct cause of ordinal data x₂ and a weight of the causality is 0.5; an edge 814 indicates that ordinal data x₂ is the direct cause of ordinal data x₄ and a weight of the causality is 0.4; an edge 816 indicates that ordinal data x₃ is the direct cause of ordinal data x₄ and a weight of the causality is 0.1.

According to example implementations of the present disclosure, the found causality 240 may be presented in a matrix. At this point, multiple dimensions of the matrix represent the multiple ordinal data, respectively, and an element of the matrix represents a weight of causality between two ordinal data corresponding to two elements among the multiple ordinal data. The causality 240 may be presented based on a matrix M below, and the matrix M represents the same causality 240 as the DAG shown in FIG. 8.

$$M = [ \begin{matrix}0 & 0.5 & 0 & 0 \\ 0 & 0 & 0 & 0.4 \\ 0 & 0 & 0 & 0.1 \\ 0 & 0 & 0 & 0\end{matrix} ]$$

With example implementations of the present disclosure, presenting the found causality 240 in the DAG or the matrix may facilitate administrators of an application system to understand causality between multiple ordinal data included in the application system, so as to further adjust the running of the application system based on the found causality 240.

According to example implementations of the present disclosure, the multiple ordinal data may represent multiple attributes of the application system. For example, in the above example, ordinal data x₁, x₂ and x₃ may represent quality levels of intermediate products in the 3 processing stages shown in FIG. 1A, and ordinal data x₄ may represent whether the final product is qualified. According to example implementations of the present disclosure, data of multiple dimensions included in a given sample may be received from multiple sensors which are deployed in the application system. For example, regarding the first sample in Table 1, data X11 may be collected from a measurement sensor deployed at a roughing device in the machining system, data X12 may be collected from a measurement sensor deployed at a finishing device in the machining system, and so on and so forth. With example implementations of the present disclosure, samples may be collected from existing sensors in the application system without deploying an extra sensor. In this way, the reuse performance of sensors in the application system may be increased.

According to example implementations of the present disclosure, a value of the ordinal data may be directly obtained. Alternatively and/or additionally, continuous data may be obtained first, and then a specific value of given ordinal data may be obtained based on the processing of the continuous data (e.g., divided by a threshold).

According to example implementations of the present disclosure, the running of the applications system may be adjusted based on the obtained causality 240. According to example implementations of the present disclosure, failures of the application system may further be eliminated based on the causality. Specifically, regarding the machining system shown in FIG. 1A, causality between each processing stage and whether the produce is qualified has been determined based on the above method. The quality control of a processing stage that most affects unqualified products may be adjusted first based on the found causality.

According to example implementations of the present disclosure, the performance of the application system may be improved based on the causality 240. Specifically, cause nodes in the causality 240 of the application system may be affected by adjustment, monitoring and other means, and then the performance of the application system may be improved. In addition, the improvement or performance boost of the application system may be promoted by automatically outputting the analysis result (the causality 240) if a predetermined condition is met. As an example, for the power transmission system shown in FIG. 1B, suppose that causality between the intermediate voltage at each transmission device and power loss has been determined based on the above method, then the intermediate voltage at the transmission device that exerts the greatest impact on power loss may be adjusted first. In this way, the performance of the power transmission system may be increased.

It will be understood although how to determine causality between multiple ordinal data has been described by taking the machining system and the power transmission system as specific examples of the application system, the method 300 according to example implementations of the present disclosure may further be applied in other types of application systems. According to example implementations of the present disclosure, in a product analysis system, questionnaires may be issued to users, and various attributes (for example, price, taste, information acquisition methods, etc.) of a certain product and results of and users' purchase intentions may be collected. Results may use a score between 1 and 5 to represent the user experience. At this point, a product attribute that most affects the purchase intention may be determined, which helps to improve the product quality and increase the product sales. In addition, the analysis performance of the product analysis system may be increased based on updated product attributes which are further received.

Further, the method may comprise regularly or irregularly receiving/obtaining ordinal data of the application system so as to continuously update or improve the causal structure analysis.

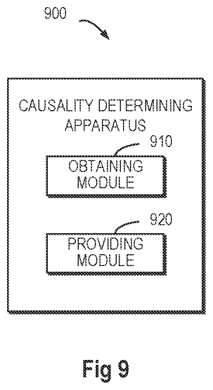

Details about the method for determining the causality have been described with reference to FIGS. 2 to 8. Hereinafter, various modules in an apparatus for determining causality will be described with reference to FIG. 9. This figure schematically shows a block diagram of an apparatus 900 for determining causality between multiple ordinal data according to one implementation of the present disclosure. The apparatus 900 comprises: an obtaining module 910 configured to obtain multiple samples associated with the multiple ordinal data in an application system, each sample among the multiple samples comprising multiple dimensions, a dimension among the multiple dimensions corresponding to ordinal data among the multiple ordinal data; and a providing module 920 configured to, based on the multiple samples, provide a first causal structure and a second causal structure that represent causality between the multiple ordinal data, the second causal structure being obtained based on the first causal structure.

According to example implementations of the present disclosure, the first causal structure comprises an initial causal structure of the causality, the second causal structure comprising an adjacent causal structure of the causality, the adjacent causal structure being obtained in adjacent scope of the initial causal structure.

According to example implementations of the present disclosure, there is further comprised: a receiving module configured to receive expert knowledge representing a constraint in the causality; and the providing module further comprises: an expert knowledge module configured to provide the adjacent causal structure based on the multiple samples and the expert knowledge.

According to example implementations of the present disclosure, the expert knowledge module comprises: an initial structure determining module configured to determine the initial causal structure of the causality based on the expert knowledge.

According to example implementations of the present disclosure, the providing module 920 further comprises: an objective function generating module configured to generate an objective function for obtaining the causality based on the multiple samples; and a search module configured to search for the adjacent causal structure in adjacent scope of the initial causal structure based on the objective function, the adjacent causal structure causing the objective function to meet a predetermined condition.

According to example implementations of the present disclosure, the objective function generating module comprises: an association determining module configured to determine an association associated with the multiple samples; and a generating module configured to generate the objective function based on the association.

According to example implementations of the present disclosure, the association determining module comprises: a threshold determining module configured to determine a set of threshold estimations associated with ordinal data among the multiple ordinal data based on the multiple samples; and an association module configured to determine the association based on the set of threshold estimations and the multiple samples.

According to example implementations of the present disclosure, the objective function generating module is further configured to: generate the objective function based on the association and the number of effective causality among the causality.

According to example implementations of the present disclosure, there is further comprised: an effective sample size receiving module configured to receive an effective sample size associated with the causality; and the objective function generating module is further configured to generate the objective function based on the association and the effective sample size.

According to example implementations of the present disclosure, the search module comprises: an adding module configured to, in the adjacent scope of the initial causal structure, add an edge into the initial causal structure to form the adjacent causal structure.

According to example implementations of the present disclosure, the predetermined condition comprises that the adjacent causal structure maximizes the objective function.

According to example implementations of the present disclosure, there is further comprised: an expert knowledge receiving module configured to receive expert knowledge representing a constraint in the causality, wherein the adjacent causal structure meets the expert knowledge.

According to example implementations of the present disclosure, regarding first ordinal data and second ordinal data among the multiple ordinal data, the expert knowledge comprises at least any of: the first ordinal data and the second ordinal data have direct causality; the first ordinal data and the second ordinal data do not have direct causality; the first ordinal data is the cause of the second ordinal data; the first ordinal data is not the cause of the second ordinal data; the first ordinal data is the result of the second ordinal data; and the first ordinal data is not the result of the second ordinal data.

According to example implementations of the present disclosure, there is further comprised: a verifying module configured to verify the adjacent causal structure based on the expert knowledge.

According to example implementations of the present disclosure, the search module is further configured to: search for a further adjacent causal structure of the adjacent causal structure in adjacent scope of the adjacent causal structure.

According to example implementations of the present disclosure, the search module is further configured to: search for the further adjacent causal structure that meets expert knowledge of a constraint in the causality in the adjacent scope of the adjacent causal structure.

According to example implementations of the present disclosure, there is further comprised at least any of the following: a graph presenting module configured to present the second causal structure in a directed acyclic graph, a node in the directed acyclic graph representing ordinal data among the multiple ordinal data, and an edge in the second causal structure representing causality between two ordinal data among the multiple ordinal data; and a matrix presenting module configured to present the second causal structure in a matrix, multiple dimensions of the matrix representing the multiple ordinal data, respectively, and an element of the matrix representing a weight of causality between two ordinal data corresponding to the element among the multiple ordinal data.

According to example implementations of the present disclosure, the multiple ordinal data represents multiple attributes of the application system.

According to example implementations of the present disclosure, the obtaining module 910 is further configured to: regarding a given sample among the multiple samples, receive data of multiple dimensions included in the given sample from one or more sensors deployed in the application system, respectively.

According to example implementations of the present disclosure, there is further comprised at least any of: a performance improving module configured to improve performance of the application system based on the causality; and a troubleshooting module configured to eliminate failures in the application system based on the causality.

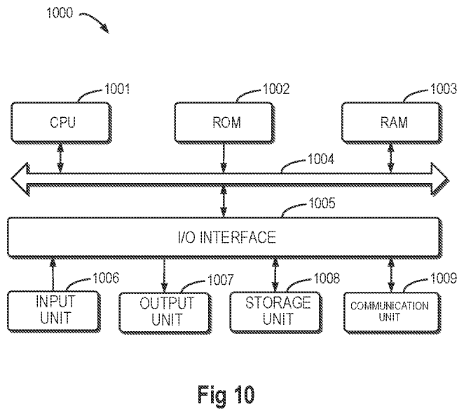

FIG. 10 shows a schematic block diagram of a device for information processing according to one implementation of the present disclosure. As depicted, the device 1000 includes a central processing unit (CPU) 1001, which can execute various suitable actions and processing based on the computer program instructions stored in the read-only memory (ROM) 1002 or computer program instructions loaded in the random-access memory (RAM) 1003 from a storage unit 1008. The RAM 1003 can also store all kinds of programs and data required by the operations of the device 1000. CPU 1001, ROM 1002 and RAM 1003 are connected to each other via a bus 1004. The input/output (I/O) interface 1005 is also connected to the bus 1004.

A plurality of components in the device 1000 are connected to the I/O interface 1005, including: an input unit 1006, such as a keyboard, mouse and the like; an output unit 1007, e.g., various kinds of displays and loudspeakers etc.; a storage unit 1008, such as a magnetic disk and optical disk, etc.; and a communication unit 1009, such as a network card, modem, wireless transceiver and the like. The communication unit 1009 allows the device 1000 to exchange information/data with other devices via the computer network, such as Internet, and/or various telecommunication networks.

The above described process and treatment, such as the methods 300 and 700 can also be executed by the processing unit 1001. For example, in some implementations, the methods 300 and 700 can be implemented as a computer software program tangibly included in the machine-readable medium, e.g., the storage unit 1008. In some implementations, the computer program can be partially or fully loaded and/or mounted to the device 1000 via ROM 1002 and/or the communication unit 1009. When the computer program is loaded to the RAM 1003 and executed by the CPU 1001, one or more steps of the above described methods 300 and 700 can be implemented.

According to example implementations of the present disclosure, an electronic device is provided, comprising: at least one processing unit; at least one memory, coupled to the at least one processing unit and storing instructions to be executed by the at least one processing unit, the instructions, when executed by the at least one processing unit, causing the device to perform the method described above.

According to example implementations of the present disclosure, a computer-readable storage medium is provided, containing computer-readable program instructions stored thereon which are used to perform the method described above.

The present disclosure can be a method, device, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but is not limited to, an electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages consist of object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where a remote computer is involved, the remote computer can be connected to the user computer via any type of network, including local area network (LAN) and wide area network (WAN), or to the external computer (e.g., connected via Internet using an Internet service provider). In some implementations, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow charts and/or block diagrams of method, apparatus (system) and computer program products according to implementations of the present disclosure. It should be understood that each block of the flow charts and/or block diagrams and the combination of various blocks in the flow charts and/or block diagrams can be implemented by computer-readable program instructions.

The computer-readable program instructions can be provided to the processing unit of a general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions stipulated in one or more blocks of the flow chart and/or block diagram.

The computer-readable program instructions can also be loaded into a computer, other programmable data processing apparatuses or other devices, so as to execute a series of operation steps on the computer, the other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow charts and block diagrams in the drawings illustrate system architecture, functions and operations that may be implemented by system, method and computer program products according to a plurality of implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order depending on the functions involved. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each implementation, or enable others of ordinary skill in the art to understand implementations of the present disclosure.

1. A method for information processing, comprising:
obtaining multiple samples associated with multiple ordinal data in an application system, each sample among the multiple samples comprising multiple dimensions, a dimension among the multiple dimensions corresponding to ordinal data among the multiple ordinal data; and
based on the multiple samples, providing a first causal structure and a second causal structure that represent causality between the multiple ordinal data, the second causal structure being obtained based on the first causal structure.

2. The method of claim 1, wherein the first causal structure comprises an initial causal structure of the causality, the second causal structure comprising an adjacent causal structure of the causality, the adjacent causal structure being obtained in adjacent scope of the initial causal structure.

3. The method of claim 2, further comprising: receiving expert knowledge representing a constraint in the causality; and
wherein providing the first causal structure and the second causal structure further comprises: providing the adjacent causal structure based on the multiple samples and the expert knowledge.

4. The method of claim 3, wherein providing the adjacent causal structure based on the multiple samples and the expert knowledge further comprises: determining the initial causal structure of the causality based on the expert knowledge.

5. The method of claim 2, wherein providing the adjacent causal structure based on the multiple samples further comprises:
generating an objective function for obtaining the causality based on the multiple samples; and
searching for the adjacent causal structure in adjacent scope of the initial causal structure based on the objective function, the adjacent causal structure causing the objective function to meet a predetermined condition.

6. The method of claim 5, wherein generating the objective function based on the multiple samples comprises:
determining an association associated with the multiple samples; and
generating the objective function based on the association.

7. The method of claim 6, wherein determining the association associated with the multiple samples comprises:
determining a set of threshold estimations associated with ordinal data among the multiple ordinal data based on the multiple samples; and
determining the association based on the set of threshold estimations and the multiple samples.

8. The method of claim 6, wherein generating the objective function based on the association further comprises: generating the objective function based on the association and the number of effective causalities among the causality.

9. The method of claim 6, further comprising: receiving an effective sample size associated with the causality; and
wherein generating the objective function based on the association further comprises: generating the objective function based on the association and the effective sample size.

10. The method of claim 5, wherein searching for the adjacent causal structure comprises: in the adjacent scope of the initial causal structure, adding an edge into the initial causal structure to form the adjacent causal structure.

11. The method of claim 5, wherein the predetermined condition comprises that the adjacent causal structure maximizes the objective function.

12. The method of claim 5, further comprising: receiving expert knowledge representing a constraint in the causality, wherein the adjacent causal structure meets the expert knowledge.

13. The method of claim 3, wherein regarding first ordinal data and second ordinal data among the multiple ordinal data, the expert knowledge comprises at least any of:
the first ordinal data and the second ordinal data have direct causality;
the first ordinal data and the second ordinal data do not have direct causality;
the first ordinal data is the cause of the second ordinal data;
the first ordinal data is not the cause of the second ordinal data;
the first ordinal data is the result of the second ordinal data; and
the first ordinal data is not the result of the second ordinal data.

14. The method of claim 13, further comprising: verifying the adjacent causal structure based on the expert knowledge.

15. The method of claim 5, wherein providing the adjacent causal structure based on the multiple samples comprises: searching for a further adjacent causal structure of the adjacent causal structure in adjacent scope of the adjacent causal structure.

16. The method of claim 15, wherein searching for the further adjacent causal structure comprises: searching for the further adjacent causal structure that meets expert knowledge of a constraint in the causality in the adjacent scope of the adjacent causal structure.

17. The method of claim 1, further comprising at least any of:
presenting the second causal structure in a directed acyclic graph, a node in the directed acyclic graph representing ordinal data among the multiple ordinal data, and an edge in the second causal structure representing causality between two ordinal data among the multiple ordinal data; and
presenting the second causal structure in a matrix, multiple dimensions of the matrix representing the multiple ordinal data respectively, and an element of the matrix representing a weight of causality between two ordinal data corresponding to the element among the multiple ordinal data.

18. The method of claim 1, wherein the multiple ordinal data represents multiple attributes of the application system, and obtaining the multiple samples comprises: regarding a given sample among the multiple samples, receiving data of multiple dimensions included in the given sample from one or more sensors deployed in the application system respectively; and wherein the method further comprises at least any of:
improving performance of the application system based on the causality; and
eliminating failures in the application system based on the causality.

19-40. (canceled)

41. An electronic device, comprising:
at least one processing unit;
at least one memory, coupled to the at least one processing unit and storing instructions to be executed by the at least one processing unit, the instructions, when executed by the at least one processing unit, causing the device to perform a method, the method comprising:
obtaining multiple samples associated with multiple ordinal data in an application system, each sample among the multiple samples comprising multiple dimensions, a dimension among the multiple dimensions corresponding to ordinal data among the multiple ordinal data; and
based on the multiple samples, providing a first causal structure and a second causal structure that represent causality between the multiple ordinal data, the second causal structure being obtained based on the first causal structure.

42. A computer-readable storage medium, with computer-readable program instructions stored thereon, the computer-readable program instructions being used to perform a method, the method comprising:
obtaining multiple samples associated with multiple ordinal data in an application system, each sample among the multiple samples comprising multiple dimensions, a dimension among the multiple dimensions corresponding to ordinal data among the multiple ordinal data; and
based on the multiple samples, providing a first causal structure and a second causal structure that represent causality between the multiple ordinal data, the second causal structure being obtained based on the first causal structure.
